(19) United States
(12) Patent Application Publication
(10) Pub. No.: US 2013/0008855 A1
(43) Pub. Date: Jan. 10, 2013

(54) IMPREGNATED CARBON FOR WATER TREATMENT

(75) Inventors: Kenn R. Vest, Davidson, NC (US); Arvind S. Patil, Davidson, NC (US)

(73) Assignee: SURFATAS, LLC, Huntersville, NC (US)

(21) Appl. No.: 13/636,231

(22) PCT Filed: Mar. 22, 2010
(86) PCT No.: PCT/US10/28118

§ 371 Date: Sep. 20, 2012

(51) Int. Cl. B01J 39/18; B01D 15/04; B01J 39/24; B01J 41/12; B01J 41/18

(52) U.S. Cl. 210/670; 252/180; 252/181; 210/679

(57) ABSTRACT

A method for treating aqueous solutions, wherein a filtrate material is manufactured to have a polymer with ion exchange properties adhered to the surface or impregnated within a porous, granular particle such that the resultant structure does not result in any agglomeration or binding of the granular particles, thereby retaining the maximum surface area of the particle for reacting with metal impurities in solution. A filtrate material comprised of a porous granulated particle and an ion exchange polymer. A method of treating aqueous solutions by passing an aqueous solution through the filtrate material to remove metal impurities in the solution. A method of regenerating the filtrate material that is saturated with metal impurities.

### FIELD OF THE INVENTION

The present invention relates generally to carbon based, particulate materials useful for treating aqueous solutions. Also, this invention relates to a method for manufacturing carbon based, particulate material for use in treating aqueous solutions. More particularly, the present invention utilizes polymer impregnated, carbon based particulate material to remove dissolved metal and other ionic contaminants dissolved in aqueous solutions. The present invention also provides a method to impregnate carbon or other porous granular media of various sizes with polymeric ion exchange compounds, including polycarboxylic acid, polyamines, and polyimines in a manner which does not result in any agglomeration or binding of the granular particles together.

### CROSS-REFERENCE TO RELATED APPLICATION

None

### BACKGROUND OF INVENTION

The removal of metal contaminants and organic compounds from aqueous solutions, including water, is an increasingly important environmental concern. In addition to drinking water necessitating treatment, other sources of water such as acid mine drainage water, industrial waste water, and municipal waste water must all be treated. These water solutions may contain metal ions that need to be removed. Some of the metal ions that may be contained within the water are toxic, while other metal ions can be valuable. Thus, a need exists for a method by which quantities of water may be treated to remove the metal ion impurities and whereby such impurities may be collected. In addition to metal contaminants, examples of organic contaminants in drinking water which can be of concern include disinfectant by-products from chlorination, various pesticides, solvents, gasoline hydrocarbons, and numerous pharmaceutical compounds which can find their way into surface and ground waters.

Removal of metal ion impurities from water is often performed on an industrial scale by use of harsh chemicals. Use of chemicals to remove and recover toxic metal ions from aqueous solutions has been widespread. Such techniques include chemical precipitation, ion exchange, reverse osmosis, electrodialysis, solvent extraction (liquid ion exchange), and chemical deduction. (See U.S. Pat. No. 5,279,245). However, these procedures typically suffer the disadvantages of incomplete metal ion removal, high reagent and energy requirements, and generation of toxic sludge or other waste products that require disposal. Removal of organic contaminants involves the use of activated carbon and can include the processes outlined above.

Further, federally mandated cleanup standards require that effluents discharged to public waters generally contain less than 1 mg/L of metals such as copper, zinc, cadmium, lead, mercury and manganese. Thus, removal techniques must be efficient enough to remove the metal contaminants to ensure compliance with the federal regulations while remaining economically viable for municipalities. There are also US EPA regulations and guidelines for the treatment and removal of organic impurities.

Currently, there are numerous methods and materials used to remove metal ions from aqueous solutions. Typically, in potable and industrial water treatment, as well as waste water treatment, several types of granular media are currently used to aid in the removal or reduction of a broad spectrum of dissolved metals. Such metals include lead, cadmium, mercury, and arsenic, to name a few. These granular media are typically ion exchange resins in the form of polymeric beads. A few years ago, carbon based media was developed (U.S. Pat. No. 6,843,922) which used a polymeric binder with ion exchange capacity. One example of which was polycarboxylic acid (specifically polyacrylic acid, known as PAA) to agglomerate fine, activated carbon powder into larger granules. This allowed the filter media to have improved properties when compared to the then existing polymeric ion exchange beads without carbon, due to the surface area and sorbent capacity of the carbon itself.

Despite the improvements to the state of the art represented by U.S. Pat. No. 6,843,922, several problems with the use of activated carbon based, polymeric materials remain. Problems associated with this treatment media include poor structural integrity of the granule due to variation in the mixing and curing process. Also, there is a tendency for the binder to occlude the pores of the activated carbon. This reduces surface area and reduces the sorbent capacity of the carbon for other organic contaminants. Control of the resulting particle size after agglomeration is also difficult and necessitates additional steps to sort and potentially grind the resulting larger granules into more usable sizes.

Thus, there exists a need for a more effective method by which to remove metal ions in aqueous solutions. More specifically, there is a need for an activated carbon based particulate material that overcomes the problems in the current art. Namely, a need exists for an activated carbon based particulate material that does not necessitate additional processing to achieve a useable and effective size. Further, a need exists for an activated carbon based, particulate material that does not block the pores on the carbon thereby reducing the treatment effectiveness of the material. Still further, there exists a need for an improved method of manufacturing an activated carbon based, particulate material that is less expensive than current methods used in the art. It is these problems that the current invention overcomes by providing the ability to produce an activated carbon based metal reduction media through impregnation versus agglomeration. This results in superior contaminant reduction performance and structural integrity of the particles, with a far lower manufacturing cost. This economic advantage is achieved by eliminating the steps necessary to agglomerate fine powders and subsequently, grind or resize the media after production.

### BRIEF SUMMARY OF THE INVENTION

The present invention relates to a new filtrate material and method for its manufacture. More specifically, the present invention provides a new method for manufacturing activated carbon based filtrate media used to remove dissolved metals and other organic contaminants from aqueous solutions. The present invention is based upon a novel process which allows the impregnation of activated carbon or other porous granular media of various types and sizes with polymeric ion exchange compounds. This new process allows the combination of the granular material and the ion exchange polymer to occur in a manner which does not result in any agglomeration or binding of the carbon particles together. This process of combination allows for more of the surface area of the coated porous carbon to be exposed than do conventional methods, without interfering with the other sorbent properties of the material.

The process proceeds without chemically binding the carbon particles to each other. Rather, the process traps the polymeric solutions in the carbon pore structure thereby retaining more of the surface area of the carbon for reacting with the waterborne contaminants, while effectively impregnating the carbon pore structure with the polymeric ion exchange material. Since there is no binding or agglomeration of the carbon, the ideal particle size of the carbon can be selected and utilized, and there are no issues with the structural integrity of the resulting particles. With very minimal effort, the substantial proportion (80-95+%) of original particle size in the end product can be realized. This represents a significant improvement over the prior art, and, specifically, over the teachings of U.S. Pat. No. 6,843,922, where considerable effort is needed in agglomeration and subsequent grinding and sieving to realize the desired particle size distribution. Moreover, various types of activated carbon can be used in the present invention, including coconut shell, bituminous, lignite, wood based, and bamboo. Further, various types of ion exchange polymers can be used as well, including those with either anionic or cationic properties.

In the most general terms, the present invention relates to a filtrate material for treating liquid solutions. The filtrate material or media is formed by a porous, granulated material. The granulated material is not agglomerated and does not experience binding of the particles together. The granulated material is combined with a polymer having ion exchange properties. More specifically, the present invention is a filtrate media wherein the granular particles are not chemically bonded to each other by the polymer.

Specifically, the present invention relates to a filtrate material where the polymeric ion exchange compounds are trapped inside the granular carbon pore structure. This trapping allows for the granular particle to continue to expose high levels of surface area despite being impregnated with the polymeric material and thus maintaining the intrinsic capacity of the activated carbon to remove organic contaminants. The present invention also contemplates use of polymeric material that has anionic or cationic properties.

The present invention contemplates and provides a filtrate material wherein the granular material can be activated carbons, titania, alumina, zirconia, iron oxides, zinc oxides, manganese sands, diatomeaceious earths, and clays, or any other sponge-like porous product with a large internal surface.

The present invention also provides and discloses a filtrate material for treating solutions that is made from a porous, unagglomerated and unbound granular material and a polymer. The polymer is impregnated within the granular material and has ion exchange properties.

The present invention also allows the ion exchange capacity of the impregnated filtrate material to be regenerated once the ion exchange capacity has been exhausted after contact with sufficient levels of dissolved waterborne metal contaminants. Once all of the ion exchange sites on the filtrate material have been saturated, and further ion exchange cannot occur, it is possible to regenerate the ion exchange sites by contacting the material with a 5% acid (HCL) solution (for cations), or caustic soda (NaOh) (for anions), followed by a water flush. This restores the ion exchange capacity of the filtrate material, which is once again capable of removing water soluble metal contaminants. This regeneration step allows the filtrate material to have extended life resulting in greater cost effectiveness. Once the ions are transferred to the acidic or basic solutions, they can be recovered, providing certain additional benefits for industries including mining. It should be appreciated that many acid solutions and caustic solutions can be used for regenerating the filtrate material, and the invention is not limited to hydrochloric acid and sodium hydroxide solutions.

The present invention is also directed to a method of manufacturing a filtrate material with ion exchange properties. The method includes providing a porous, unagglomerated and unbound granular particle and impregnating the particle with a polymer that has ion exchange properties. Once blended, the polymer is crosslinked in order to adhere the polymer to the surface of the granular particle. The present invention also contemplates blending the granular material and the polymer so that the granular particle is impregnated with the polymer. Further, the present invention contemplates adding a solvent to adjust the viscosity of the polymer to facilitate the impregnation into the macro and micropores of the granular particle. Further, the present invention contemplates adding a cross-linking agent to aid in cross-linking the polymer after impregnation of the granular material. The cross-linking agent can be selected from such cross-linking agents as dicarboxylic acid, glutaric acid, succenic acid, and malonic acid. Moreover, the present invention further contemplates adding the step of heating the filtrate material to further cross-link the polymer.

The present invention is also directed to a method for treating liquid solutions with a filtrate material. More specifically, the filtrate material is a porous, unagglomerated and unbound granular material, combined with a polymer that has ion exchange properties. The polymer is immobilized on the surface of the granular material or impregnated in the granular material. A liquid solution is passed through the filtrate material and metal and other impurities are removed from the solution. The present invention further contemplates that the granular particle is an activated carbon. The present invention also contemplates the step of recovering the metal and other organic impurities that are removed from the solution.

### BRIEF DESCRIPTION OF THE DRAWINGS

There are no drawings associated with the present invention.

### DETAILED DESCRIPTION OF THE INVENTION

In the present specification, the terms sorb, sorbing, and sorption are used in the broad sense and as used herein are defined to include all forms of metal and other contaminant uptake and securing, whether by adsorption, absorption, ionic bonding (including ion exchange), among other forms of metal uptake and securing. Parts per million (ppm) and parts per billion (ppb) refer to parts by weight.

The main objective of the present invention is to coat, infuse and/or impregnate fine sized activated carbon particles with polymeric materials with ion exchange properties. The polymeric compounds have pendent end groups that are capable of imparting ion exchange properties. The present invention cross links these polymers in order to secure them to the surface substrate (the porous granular particles) and make them insoluble in water, using a suitable catalyst and/or high temperature. The filtrate material is ideally used as an additive in municipal water treatment facilities to remove heavy metals and organic contaminants, or as an additive in industrial applications where dissolved metals and organic contaminants are present in aqueous solutions.

Although this invention is specifically directed to activated carbon due to its ability to treat aqueous solutions, any high surface porous matrix and or fine particulate media can be used as the substrate. Examples of fine sized media that can be used include activated carbons, titania, alumina, zirconia, iron oxides, zinc oxides, manganese sands, diatomaceous earths, clays and various kinds of sponge-like porous products with large internal surface. Since after cross-linking the polymers are irreversibly immobilized on the surface substrate in a fine, spaghetti-like network, thus leaving the majority of the pores and surface of the underlying substrate exposed. This results in the substrate retaining its inherent properties to remove organic impurities but adds an ion exchange capability to the filtrate media. Such multi-functional capabilities are particularly valuable in consumer water treatment devices where there are space constraints. In a preferred embodiment, granulated, activated carbon (GAC) is used as the fine, particulate substrate.

The polymer used for creating cation exchange capacity for the substrate includes various polycarboxylic acids. In a preferred embodiment, polyacrylic acid (PAA) is used. However, polymethacrylic acid polymers can also be used. The molecular weight of the PAA should be 10,000 to 500,000. In a preferred embodiment, the molecular weight of the PAA should be 200,000 to 400,000. The cross linking catalyst is a polyalcohol, preferably glycerol. However, ethylene glycol, 1,2 propanediol, 1,3 propanediol, or polyvinyl alcohol can also be used.

The polymer used for creating anion exchange capacity for the substrate includes polyimine, polyamine, or polydiallyldimethyl ammonium chloride (DADMAC). The molecular weight of these polymers should be between 500,000 to 1.5 million. The cross liking agent should be a dicarboxylic acid. In a preferred embodiment, glutaric acid is used. However, succenic and malonic acid can also be used.

In a preferred embodiment, the optimum weight percentages on dry basis of granular activated carbon (GAC), polymer and crosslinking catalyst are as follows:
1) GAC: 60-80%,
2) Polymer: 20-40%,
3) Crosslinking Agent: 1-10% of polymer, and
4) Water: only as needed to assist impregnation.

The objective of cross linking the polymer is to bring about entanglement of polymer chains on the surfaces of and within the porosity of the substrate particles. This allows the polymers to be permanently secured to the surface of the granular particle. Care must be taken to not exceed the optimum amount of cross-linking early in the process because excessive polymer cross linking in the initial stages reduces the final ion exchange capacity. Thus, only a portion of the polymer needs to be cross-linked. Too much cross-linking early in the process is detrimental because it reduces the carboxylic acid and amine groups that are responsible for creating the ion exchange capacity. It has been found that a minimum amount of cross linking polymer should be added and is around 1% of the weight of polymer on a dry basis. Lower cross-linking at the early stage is acceptable since later on in the manufacturing process further cross linking is achieved by thermal treatment. Again, however, care must be taken because excess thermal treatment will also lead to the loss of ion exchange capacity.

In the following discussion describing the quantitative addition of polymeric solutions to the porous substrates, a preferred embodiment utilizing activated carbon as the example substrate will be used. It should be understood and readily apparent to those skilled in the art that similar substrates can also be used. Considerations regarding the quantities used for various additives will vary depending on the surface area of alternative substrates and their pore size and distribution.

Since the objective of the present invention is to impregnate the polymer solution into the surface pores of the substrate (activated carbon in the preferred embodiment), appropriate viscosity of the polymer solution must be ensured. If the polymer solution is too viscous to penetrate the surface pores of the substrate, water or other solvent can be added to the solution to lower the viscosity. Since the objective is to not occlude or cover the surface of the substrate, the percentage of polymer that is cross polymerized should be properly controlled. In the preferred embodiment, this quantity for activated carbon has been determined to be in the range of 5 to 40% by the weight of activated carbon. These amounts of cross polymerization will not alter the intrinsic properties of the carbon, such as the Iodine number (which indicates the adsorption capacity of activated carbon for organic molecules per unit weight of the carbon), yet will still impart the added property of ion exchange to the activated carbon filtrate media. As can be seen, the optimum loading of polymer will, therefore, vary depending on the nature of the porous material, its surface area, and pore size distribution. As one skilled in the art can readily appreciate, however, it is possible to undertake higher loading of cross polymerization on the substrate, provided that the main purpose to be achieved is to provide an anchor for the polymer and the intrinsic properties of the substrate are secondary in importance. Thus, on an inert porous substrate such as very fine manganese sand, one could go to much higher loading approaching 90-100% or more of the substrate weight.

The process of impregnating the activated carbon with the polymer solution initially requires adding polymer/cross linking catalyst solution of optimum viscosity to the carbon and thoroughly mixing the resulting paste. This can be achieved using either a sigma mixer, pin mixer, ribbon mixer, screw mixer with twin axis rotation, or any other means that ensures complete wetting of the substrate material by the polymer solution. Typically the polymer paste will have 25-50% solids at this stage, with the balance being a solvent such as water. Typical solvents can also include alcohols. After mixing, the paste is dewatered and subjected to thermal cross linking by raising it to sufficiently elevated temperature to bring about sufficient cross linking. This ensures that the polymer is permanently fixed on the substrate.

During the paste stage, the polymer impregnated mass undergoes a typical course of drying. The moisture or solvent is removed by exposure to an elevated temperature greater than 100° C. The paste is continually stirred and dries at a linear (constant) rate over time as the surface and subsurface moisture is removed. While drying, the consistency of the material changes from paste-like to granular. As the material becomes less paste-like and more granular, removal of moisture or solvent with time stops being linear, as the surface and subsurface moisture or solvent have been removed. Once this occurs, further moisture or solvent removal is limited by the rate of diffusion of moisture or solvent from the interior of granule. At the boundary of paste-like to granule stage, the material is at its viscosity maximum and offers the maximum resistance to stirring. As moisture or solvent removal continues, the rate of drying will slow down further as drying rate is limited by the diffusion of moisture or solvent from the interior of granules.

Despite any addition of additional heat, the temperature of the polymer impregnated carbon mass will not rise until all the solvent is removed. In order to get the optimum degree of cross linking, the temperature of the mass should reach 230-250° C. and must be held at that temperature for 1-2 hours. One of the telling characteristics of adequate cure or cross linking is the absence or minimum of swelling in the mass of the material when re wetted with water. When the carbon mass is rewetted with water, it should experience swelling of no more than 10% of its original mass. This indicates that the polymer has adequately cross-linked and has permanently adhered to the surface of the substrate. At this stage, no amount of repeated water contact will dislodge the polymer from the substrate, and its remaining carboxylic or amine groups impart permanent ion exchange capacity to the substrate.

To achieve this particular sequence of drying and curing (cross linking of polymer), various kinds of mechanical and electrical equipment can be used. For example, during the impregnation and forming of the paste, a sigma mixer, pin mixer, ribbon mixer, or screw mixer with two axis rotation may be used. In order to facilitate the removal of moisture, a vacuum can be used in conjunction with heat from an electrical, gas, or microwave source. In the granule stage, where initially the mass is in the form of big lumps or clods, various kinds of stirring and chopping means may be used to reduce the size of the lumps to powder. This will facilitate lowering the time required for removal of moisture and attainment of curing. Since the reduction of larger pieces of lumps or clod to smaller granules is essential to dewater, it is possible to take the paste and extrude it either in the form of spaghetti, thin sheets, pan-cakes, small brickettes, or pellets. Once extruded, the paste can be further subjected to thermal treatment for continued drying and curing. Also since the production of activated carbon is typically accomplished in rotating kilns, it is also possible to achieve the curing of the brickettes or pellets made from carbon-polymer mass in a rotating kiln.

The following examples illustrate various aspects of the present invention.

### Example 1

In a 150 liter volume ribbon blender a batch of polymer impregnated carbon was made using the following formulation:
a) activated carbon (20×50 mesh): 10 kg,
b) 25% PAA (Lubrizol-Carbopol-ISX-1794): 15 liters (4.28 kg dry basis),
c) glycerol: 300 ml (0.33 kg), and
d) water: 3 liters
   Activated carbon granules were loaded into the ribbon blender. In a separate reaction vessel, PAA, glycerol and water in the above quantities were mixed. This mixture was added to the granulated activated carbon (hereinafter “GAC”) in the ribbon blender under continual agitation. The speed on the agitation was maintained at 20 rpm. The mixture (now in a paste-like form) was agitated for 30 minutes and dropped out of the ribbon blender onto a tray. The paste was extruded through a roller mill into one centimeter thick sheets on trays, and these trays were subjected to heat in a conveyor dryer at 230° C. The temperature of the paste-like material in the trays was measured using an infrared thermometer. The bed temperature remained below 100° C. until substantially all the moisture had evaporated. Once the moisture evaporated, the bed temperature began to rise. Once the temperature reached 230° C., the temperature was maintained 90 to 120 minutes. Afterwards, the cured sheets were broken into small pieces and put through a hammer mill. The material was processed in the hammer mill until it returned to its original 20×50 mesh size.

After curing, the PAA added 30% to the original weight of GAC. The theoretical yield based on the formulation above was 14.61 kg. The actual yield in the example was 14.1 kg, resulting in a 97% yield. The sieve analysis of the resultant coated GAC was as follows:
a) Plus 20 mesh: 0%,
b) Plus 25 mesh: 6%,
c) Plus 30 mesh: 22%,
d) Plus 40 mesh: 54%,
e) Plus 50 mesh: 16%, and
f) Minus 50 mesh: 2%.
   As clearly seen from the data, sieve analysis shows that 98% of the product was recovered in 20×50 mesh size. It should be noted that 20×50 mesh sized particles are exactly what was originally used to begin the process, and that the end result was that there was virtually no agglomeration or binding together of the particles. The cured product was put in a 1.5 cm diameter test tube to a depth of 1 cm. The height of the column was marked, and water was added to 75% the height of the test tube. Addition of water to the cured GAC generated rapid bubbles as the carbon became wetted. After a few minutes, the solids settled down very close to the original height mark. The swelling was measured to be less than 10%, indicating that the polymer was cured adequately. If the curing or cross linking was insufficient, the uncured PAA polymer chains would expand as they became hydrated, thus causing swelling of the column. The resultant product was tested by conventional methods for cation exchange capacity. The cation exchange capacity of the product was 0.6 meq/g. The untreated GAC did not have any cation exchange capacity.

### Example 2

A trial on impregnating GAC with PAA was conducted in a 130 liter volume Littleford Ploughshare Dryer (Littleford Day, Inc. P.O. Box 128, Florence, Ky. 41022-0128). This state-of-the-art dryer has a mechanically fluidized ploughshare action which agitates and individualizes each particle, thereby continuously exposing tremendous particle surface for drying. The vessel has a heated jacket where hot oil can be circulated to attain the temperatures of approximately 495° F. or 250° C. The particles constantly contact one another, and the heated interior wall of the jacketed Littleford vessel further hastens the drying process. Additionally, the Littleford Ploughshare dryer is equipped with independently-operated, high shear choppers that reduce the particle size of the lumps or agglomerates thereby exposing un-dried materials and ensuring that the particle interiors are thoroughly dried. Combined action of the ploughshare and choppers create a fluidized bed, shortening the drying time. Use of a vacuum further allows removal of moisture at lower temperature.

The 130 liter Littleford Ploughshare Dryer was used for the second trial. Formulations used in the second trial were:
a) GAC 20×50: 25 kg,
b) 25% PAA CBP-ISX 1794: 30 liters (33 kg), and
c) glycerin: 0.085 kg.
   The 25 kg of GAC (20×50) was added to the Littleford reactor vessel. In a separate mixing vessel, the PAA and glycerol was mixed together. Once mixed, the PAA and glycerol were poured onto the GAC in the Littleford reactor vessel. The reactor top was closed sealing the reactor, and the vacuum was started at 30 inches. Agitation with the ploughshare was maintained at 75 to 85 rpm after the vessel was closed. Heated oil circulation was begun in the jacket with the temperature of oil maintained at 250° C. After 15 minutes of agitation, the resistance to ploughshare agitation increased and was noted from the amperage reading. For about 15 minutes the resistance became too high and threatened to exceed the maximum allowable amperage on ploughshare. As such, agitation was reduced to 10 rpm while continuing the temperature and vacuum on the vessel. Choppers were then used for 5 minutes to reduce the size of lumps and expose more surfaces to evaporation of moisture.

As soon as the material inside became drier and the resistance to agitation decreased, the ploughshare was set at 75 rpm. The product temperature was monitored. When the moisture was removed, the temperature started rising and rose to approximately 250° C. From this point onwards, small samples were taken out every 30 minutes for swelling testing utilizing the test described in Example 1. After the 2 hour point, the material was cured and swelling was determined to be less than 10%. The resultant product was tested by conventional methods for cation exchange capacity. The cation exchange capacity of the product was 0.55 meq/g. The untreated GAC did not have any cation exchange capacity.

### Example 3

Impregnated carbon made pursuant to the instant invention was tested for its ability to remove metallic contaminants such as lead, copper, cadmium, zinc, nickel, manganese, magnesium, chromium, and iron from water. The impregnated carbon was tested with the metal contaminants at both high concentrations (approximately 50 to 100 parts per million) and at low concentrations (wherein the concentrations of metal contaminants in the water were in the parts per billion range).

The impregnated carbon made according to the present invention was packed in a column. 100 bed volumes of metal solutions of low concentration, approximately 0.5 ppm (6.6 ppb for mercury (Hg)) at pH 7 were passed through the column. The filtrate was analyzed to determine the amount of metal reduction in the water. Table 1 shows the percent removal for various metals at low concentrations. Following the low concentration run, 100 bed volumes of metal solutions of high concentration, approximately 50 ppm (690 ppb for mercury (Hg)) at pH 7 were passed through the column. The filtrate was analyzed to determine the amount of metal reduction in the water. Table 2 shows the percent removal for various metals at high concentrations.

### Example 4

Polyacrylic acid impregnated carbon prepared according to the present invention was tested for metal removal using Rapid Small Scale Column Testing Protocol (RSSCT, as described in ICR Manual for Bench and Pilot Scale Treatment Studies (ICR, 1996)). The empty bed contact time used was 1 minute, and the hydraulic loading rate was 70 ml per sq. inch per minute. The influent concentrations for the metals were:
a) lead: 85 ppb,
b) cadmium: 100 ppb,
c) zinc: 100 ppb, and
d) copper: 100 ppb.
   The solution was maintained at a pH of 5.6. The respective graphs showing the reductions of various metals are shown in Tables 3-6. Along with the reductions in metal concentration achieved by the present invention, any reduction in metal concentrations by untreated carbon is presented for comparison. As can easily be seen in Tables 3-6, carbon without any treatment has very little capability to remove metals.

If one considers breakthrough as any effluent or filtrate concentration greater than zero contaminant level, then the reduction in respective bed volumes for various metals were:
a) copper: 27,000,
b) zinc: 1,400,
c) cadmium: 12,500, and
d) lead: 36,200.
   As seen in above examples, the impregnated activated carbon had a broad spectrum capability to remove metals.

### Example 5

In order to show that the intrinsic adsorption properties of the carbon had not changed after its impregnation with polyacrylic acid, an analysis of iodine number values was performed by titrations. Titrations were performed on both untreated and impregnated carbon. After correcting for the gain in weight due to the polyacrylic acid, the iodine numbers were determined to be 900 for untreated carbon, and 955 for polyacrylic acid impregnated carbon. Once experimental error is accounted for, these results indicate that that there is no significant change in the adsorption properties of the impregnated carbon.

### Example 6

As an example of regeneration, the column containing polyacrylic acid impregnated carbon as shown in Example 4 was treated with a 5% solution of hydrochloric acid (HCl) after it was saturated at 40,000 bed volumes of lead solution to regenerate the media. 100 bed volumes of 5% HCl were passed through the column at the rate of hydraulic loading of 70 ml per square inch per minute. Next it was flushed with water repeatedly until the filtrate of the effluent reached a pH of 6.5. The column was then ready to be reused with full ion exchange capacity restored.

Although the present invention has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

1. A filtrate material for treating liquid solutions comprising:
a porous, unagglomerated and unbound granular material impregnated with a polymeric material having ion exchange properties.

2. (canceled)

3. The filtrate material of claim 1 wherein the polymeric material is trapped inside said porous, granular material thereby exposing high levels of surface area of the polymeric ion exchange material without occluding the pores of the granular material.

4. The filtrate material of claim 1 wherein the polymer has anionic or cationic properties or a mixture thereof.

5. (canceled)

6. The filtrate material of claim 1 wherein the granular material is selected from the group consisting of carbons, titania, alumina, zirconia, iron oxides, zinc oxides, manganese sands, diatomaceous earth, and clays.

7. The filtrate material of claim 1 wherein the granular material is activated carbon selected from the group consisting of coconut shell, bituminous, lignite, wood based, and bamboo.

8. (canceled)

9. The filtrate material of claim 1 wherein the polymeric material is a polycarboxylic acid, polyacrylic acid, polymethacrylic acid or a mixture thereof.

10. (canceled)

11. (canceled)

12. The filtrate material of claim 10 wherein the molecular weight of the poly acrylic acid is about 10,000 to 500,000.

13. (canceled)

14. The filtrate material of claim 4 wherein the polymeric structure is comprised of polyimine, polyamine, or polydiallyldimethyl ammonium chloride (DADMAC).

15. The filtrate material of claim 14 wherein the molecular weight of the polymer is about 500,000 to 1,000,000.

16. (canceled)

17. A method of making a filtrate material with ion exchange properties comprising:
a) providing a porous, unagglomerated and unbound granular particle,
b) blending said granulated particle with a polymer having ion exchange properties,
c) crosslinking a portion of said polymer to adhere to the surface of said granular particle.

18. The method of claim 17 wherein the granular material is impregnated with said polymer.

19. The method of claim 17 wherein the granular particle is activated carbon.

20. The method of claim 17 further comprising the step of adding solvent to adjust the viscosity of the polymer to facilitate impregnation into the granular particle.

21. The method of claim 17 further comprising the step of adding a cross-linking agent selected from the group consisting of dicarboxylic acid, glutaric acid, succinic acid, and malonic acid.

22. (canceled)

23. The method of claim 17 further comprising the step of heating the filtrate material to further crosslink the polymer.

24. A method for treating liquid solutions comprising:
a) providing a filtrate material wherein said filtrate material comprises a porous, unagglomerated and unbound granular material impregnated with a polymer that has ion exchange properties such that said polymer is immobilized on the surface of the granular material or impregnated in the granular material, and
b) passing a liquid solution through said filtrate material.

25. The method of claim 24 wherein the granular particle is activated carbon.

26. The method of claim 24 wherein the polymer is a polycarboxylic acid, polyacrylic acid, polyimine, polyamine, polydialkyldimeththyl ammonium chloride (DADMAC), or a mixture of these.

27. (canceled)

28. (canceled)

29. (canceled)

30. (canceled)

31. (canceled)

32. The method of claim 24 further comprising the step of regenerating the filtrate material by contacting it with a concentrated acid solution to remove cationic metal impurities and flushing said filtrate material with water.

33. The method of claim 24 further comprising the step of regenerating the filtrate material by contacting it with a concentrated caustic solution to remove anionic metal impurities and flushing said filtrate material with water.

34. The filtrate material of claim 1, further comprising glycerine.
